(19) United States
(12) Patent Application Publication
(10) Pub. No.: US 2022/0309122 A1
(43) Pub. Date: Sep. 29, 2022

(54) ITERATIVE ALGORITHM FOR AERO-ENGINE MODEL BASED ON HYBRID ADAPTIVE DIFFERENTIAL EVOLUTION

(71) Applicants: DALIAN UNIVERSITY OF TECHNOLOGY, Dalian, Liaoning (CN); DUT ARTIFICIAL INTELLIGENCE INSTITUTE, DALIAN, Dalian, Liaoning (CN)

(72) Inventors: Ximing SUN, Dalian, Liaoning (CN); Chen WANG, Dalian, Liaoning (CN); Xian DU, Dalian, Liaoning (CN); Lu AI, Dalian, Liaoning (CN)

(21) Appl. No.: 17/440,093

(22) PCT Filed: Sep. 28, 2020
(86) PCT No.: PCT/CN2020/118338

§ 371 Date: Sep. 16, 2021

(51) Int. Cl. G06F 17/13; G06F 30/20

(52) U.S. Cl. CPC G06F 17/13; G06F 30/20

(57) ABSTRACT

The present invention belongs to the technical field of numerical calculation of aero-engines, and provides an iterative algorithm for an aero-engine model based on hybrid adaptive differential evolution, comprising the following steps: establishing a component-level model of an aero-engine; solving the engine model by a hybrid adaptive differential evolution algorithm; and establishing a dynamic calculation model of the aero-engine. The aero-engine model established by the algorithm of the present invention is widely suitable for traditional turbojet engines and turbofan engines, advanced integrated engine propulsion systems and variable cycle engines, can maintain the dynamic model calculation without dead engine or interruption, and satisfies real-time requirements under most operating conditions.

### TECHNICAL FIELD

The present invention belongs to the technical field of numerical calculation of aero-engines, comprises three parts of the establishment of a non-linear aerodynamic thermodynamic model of the aero-engine, the iterative solution of a non-linear model based on adaptive differential evolution and damped Newton hybrid algorithms and the construction of a non-linear dynamic model of the aero-engine, and is a research on a numerical iterative algorithm of a component-level non-linear model of the aero-engine.

### BACKGROUND

In aero-engine research, the engine mathematical model is widely used in the research work of analytical redundancy, fault diagnosis, aircraft design and control systems. In the analysis and design of the control systems, the mathematical model of the engine is an important research content. Data show that in the research of control and monitoring systems of the aero-engine, engine modeling and the understanding of power system characteristics account for 80% of the total workload. It can be seen that modeling in the design of the control systems of the aero-engine is of important significance and value.

Considering that the aero-engine is a multi-variable, non-linear and time-varying complex system, the mathematical model in the design and analysis stage of control rules is required to have high accuracy, and needs to simultaneously have steady state and dynamic characteristics. Generally, a component level non-linear aerodynamic thermodynamic model is adopted. There are mainly three requirements for the non-linear model of the aero-engine: accuracy or fidelity of numerical calculation, and real-time performance and convergence of an operational model. The accuracy is the basic requirement of quantitative description of the engine model, which mainly depends on accurate component characteristics and convergence errors of the model calculation algorithm. The real-time performance requires that the dynamic operating speed of the engine model is high enough and can be matched with the operating cycle of the control system. The convergence is the convergence of a numerical iterative algorithm in the calculation of the engine model. A real-time engine model is generally used in the semi-physical test and control system of modern engines. Therefore, the accuracy and the real-time performance of the model need to be properly compromised in modeling. In view of the strong nonlinearity of the aero-engine model and with the innovation of advanced technologies of combined cycle engines and variable cycle engines of propulsion systems, variables of the engine model are increased, complexity is increased and convergence gradually becomes a very prominent problem. Therefore, how to improve the convergence and the real-time performance of the algorithm of the engine model on the basis of satisfying the calculation accuracy becomes an urgent problem.

Scholars in China and abroad have done numerous researches on the above problems. The early iterative algorithm is mainly used for the engine simulation technology under steady state conditions, including parameter cycle methods of SPEEDY and CARPET, and the balanced cycle methods of loop nesting such as AFQUIR and DSPOOL. These methods can realize the calculation of a steady state model, but take long time for iterative calculation. Thereafter, gradient-based optimization algorithms, such as steepest descent method, N+1 residual method, Newton-Raphson method and Broyden method, are applied to numerical calculation, without nesting loop, and are initial value-based multi-iteration methods which are researched by domestic scholars of Guangqi Luo, Jiarui Li, et al. The Newton-Raphson method and Broyden quasi-newton methods are the most widely used model iteration methods, and general simulation programs of United States Air Force, such as SMOTE, GENENG and DYNENG have used the Newton-Raphson method. The traditional Newton-Raphson algorithm has quadratic convergence, but each calculation needs to iterate the jacobi matrix, with low efficiency. The Broyden method is widely used under high requirements for the real-time performance. The mainstream simulation programs of NCP of NASA, GSP of NLR and TERTS engine models adopt the Broyden method. The use of the method avoids the problem of repeated calculation of the jacobi matrix in the traditional N-R method, reduces the calculation times of the model and significantly improves the real-time performance, but the convergence stability is not as good as the traditional N-R method. The Newton-Raphson and the Broyden method, as local convergence algorithms of gradient-based iteration, have a common problem of too high dependence on the initial value, which also restricts the development of the traditional iterative algorithm applied to the “large deviation” dynamic engine model and simulation. In order to solve the problem, J. Biazar, M. A. Noor, et al. have put forward the methods of initial value fitting, finite field optimization search, component property expansion and variable step size, tried to put forward hybrid algorithm solutions of N-R and Broyden method, and improved the convergence of the model to a certain extent. However, with the expansion of the variation range of advanced engine working conditions and the increase of iteration variables, non-convergence still exists in the calculation of the large deviation dynamic model, and these solutions cannot solve the convergence problem from the root. In recent years, many scholars such as Sanmai Su, Xingbo Wang, Weijian Fan, et al. have applied advanced intelligent optimization algorithms to the problem, such as genetic algorithm and particle swarm optimization. Because of the advantage of global convergence, the intelligent algorithm can solve the problem for the model that the traditional iterative algorithm is sensitive to the initial value. However, because of the characteristics of strong nonlinearity and multiple iteration variables of the aero-engine model, the intelligent algorithm has poor real-time performance in application and is easy to rapidly fall into the problem that the local convergence cannot obtain exact solutions. How to reasonably design the iterative algorithms of the aero-engine is of great value for effective compromise of calculation real-time performance and accuracy, improvement of the convergence, expansion of the convergence range and technical development of the aero-engine model.

### SUMMARY

In order to overcome the problems of poor convergence stability of the traditional iterative algorithms of the aero-engine model and low calculation efficiency of the intelligent algorithm, the present invention proposes a hybrid iterative algorithm based on adaptive differential evolution and damped Newton's method to improve the convergence of the engine model, guarantee the calculation accuracy and real-time performance and satisfy the need of dynamic calculation of the non-linear real-time model.

The present invention has the basic idea that the engine model adopts the hybrid Damped Newton's method as a main algorithm. The present invention firstly uses the hybrid Damped Newton's method for iterative calculation in performance calculation, then adopts an adaptive differential evolution algorithm for operating points in which the main algorithm does not converge within the specified maximum iteration number, and uses the hybrid Damped Newton's method again after the number of iterative cycles of differential evolution reaches a set value, to achieve the purpose of fast convergence in the later period of iteration. The method satisfies the convergence requirements of wide range and even global range to a maximum extent by the hybrid calculation of two algorithms. In addition, high efficiency of the initial iteration of the adaptive differential evolution algorithm and the real-time performance and high accuracy advantages of small deviation initial value iteration of the hybrid Damped Newton's method are fused, to ensure the accuracy and the real-time performance of the model.

The technical solution of the present invention is as follows:

An iterative algorithm for an aero-engine model based on hybrid adaptive differential evolution comprises the following steps:

S1: establishing a component-level model of an aero-engine

S1.1: determining the number and types of components of the aero-engine model, and obtaining the characteristic curves of key components (a fan, a compressor, a turbine and the like);

S1.2: respectively establishing input and output modules of a single component according to the sequence of engine components based on aerothermodynamics, comprising gas flow equations and heat equations; and connecting the modules according to input/output relationships in combination with steady state and dynamic common working equations;

S1.3: determining known input parameters of the model based on operating conditions and states of the engine model, determining the number and types of iteration variables through the common working equations, and conducting simulation calculation according to a gas process;

S2: solving the engine model by a hybrid adaptive differential evolution algorithm

S2.1: accurately searching the solution of the model by the damped Newton's method based on the data of engine model design points (initial value table of the iteration variables) as the starting point of iteration, stopping the iteration when equilibrium equation residuals satisfy an error range, and jumping to S3;

S2.2: jumping to an adaptive differential evolution algorithm if the damped Newton's method does not converge within the maximum iteration number;

S2.3: determining the value range of each iteration variable through the characteristic curves of the engine components and actual limitations, as the variable value range of an adaptive differential evolution algorithm population; setting the initial population number of the differential evolution algorithm, selecting the initial value of an appropriate scaling factor, and determining the number of iteration termination steps and convergence termination conditions;

S2.5: selecting residuals of each common working equation of the engine model to establish a fitness function as the optimization objective function;

S2.6: obtaining optimal variable parameters searched by the differential evolution algorithm through the operation of mutation, crossover and selection.

S2.7: accurately searching the solution of the model by the damped Newton's method based on a variable parameter obtained by the differential evolution algorithm as an iteration initial value, and stopping the iteration when the equilibrium equation residuals satisfy the error range;

S3: establishing a dynamic calculation model of the aero-engine

S3.1: designing the component-level model and the iterative algorithm of the aero-engine by C++ programming, introducing a dynamic link library to encapsulate the engine iteration model, and introducing into simulink module;

S3.2: determining the sampling time of a dynamic process, and determining the input conditions of the model according to the actual working conditions of the engine to realize the simulation of the dynamic process of the aero-engine.

The present invention has the beneficial effects that: the hybrid adaptive differential evolution algorithm proposed by the present invention integrates high local calculation efficiency of the traditional Newton iteration method and the global convergence of the differential evolution algorithm, improves the convergence stability of the iteration of the aero-engine model, maintains high calculation efficiency, makes the model suitable for the calculation of a state point with a large deviation from the initial value of the variable, and makes the engine model still have good convergence stability under wide operating condition variation ranges. Therefore, the aero-engine model established by the algorithm of the present invention is widely suitable for traditional turbojet engines and turbofan engines, advanced integrated engine propulsion systems and variable cycle engines, can maintain the dynamic model calculation without dead engine or interruption, and satisfies real-time requirements under most operating conditions.

### DESCRIPTION OF DRAWINGS

FIG. 1 is a flow chart of a typical propulsion system part model.

FIG. 2 is a schematic diagram of a calculation flow of a hybrid adaptive differential evolution algorithm.

FIG. 3 is a flow chart of an adaptive differential evolution algorithm.

FIG. 4 is a schematic diagram of a simulink platform for calculation of a dynamic process of an aero-engine.

FIG. 5 is a variation curve of dynamic errors of a small deviation dynamic process over time.

FIG. 6 is a variation curve of the number of component calculation of a small deviation dynamic process over time.

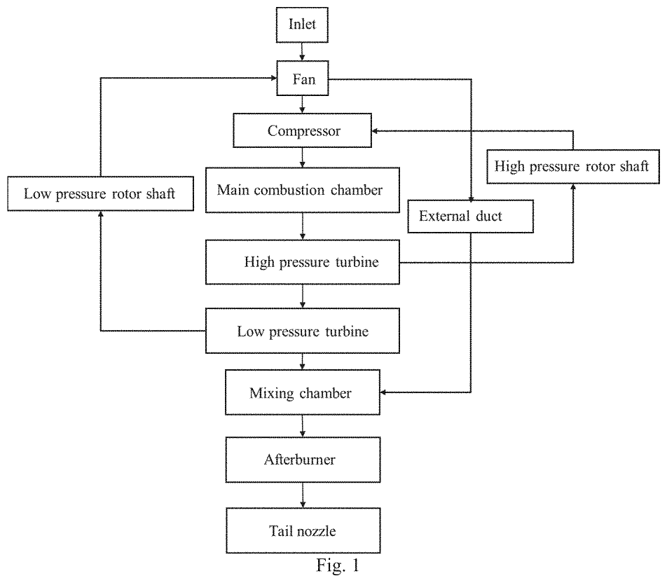

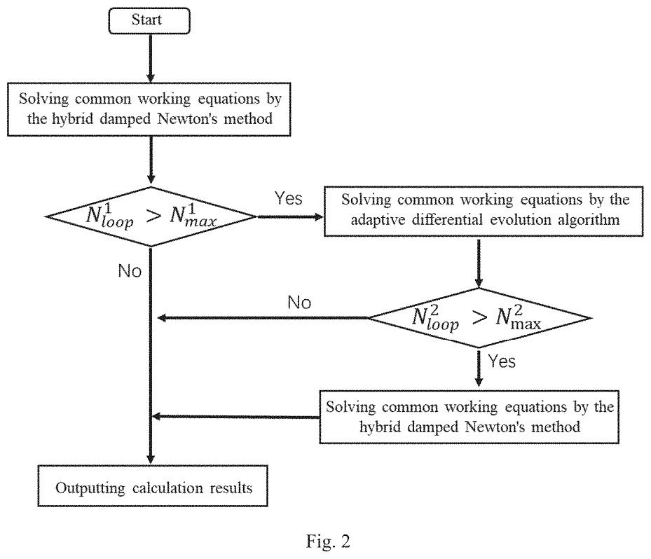

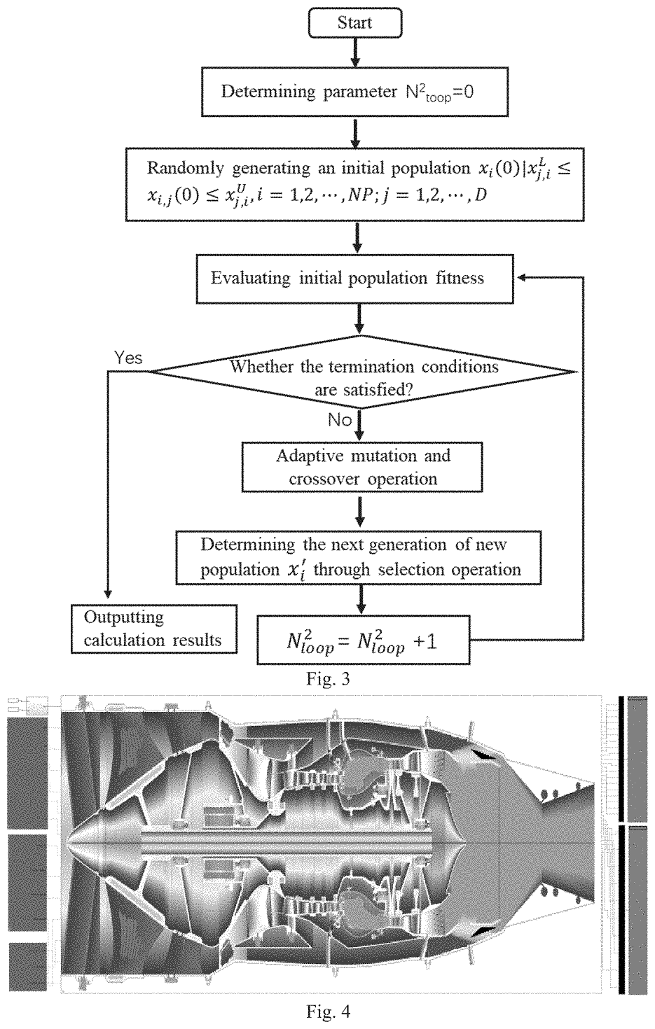

### DETAILED DESCRIPTION

The embodiments of the present invention will be further described in detail below in combination with the drawings and the technical solution.

An iterative algorithm for an aero-engine model based on hybrid adaptive differential evolution comprises the following steps:

S1: establishing a component-level model of an aero-engine

S1.1 establishing input and output modules of a component-level inlet, a fan, a compressor, a combustion chamber, a high pressure turbine, a low pressure turbine, an external duct, a mixing chamber, an afterburner and a tail nozzle based on gas flow and aerothermodynamic formulas, wherein the modeling of the key components (the fan, the compressor, the turbine and the like) mainly adopts an interpolation method including characteristic lines, and different characteristic lines are used for different engine models.

S1.2: simultaneously satisfying flow, power and rotor dynamic equilibrium equation when the engine is in a steady state or dynamic working state, and representing the residual of the rotor dynamic equilibrium equation by e; based on different calculation needs, selecting n independent variables x and conducting simultaneous solving of n common working equations:

$${f}_{1} ( {x}_{0} , {x}_{1} , {x}_{2} , … , {x}_{n} ) = {e}_{1} \\ {f}_{2} ( {x}_{0} , {x}_{1} , {x}_{2} , … , {x}_{n} ) = {e}_{2} \\ … … \\ {f}_{n} ( {x}_{0} , {x}_{1} , {x}_{2} , … , {x}_{n} ) = {e}_{n}$$

S1.3: determining environmental input parameters of the model based on the operating state of the engine model: mach number, flight height, main fuel flow, afterburner fuel flow and tail nozzle area, wherein the problem essentially becomes non-linear implicit equations with unknown independent variables, and the engine model is considered to obtain a reliable solution when six residual values of the common working equation approach 0;

S2: solving the engine model by a hybrid adaptive differential evolution algorithm

In order to solve the non-linear implicit equations of the aero-engine model, a hybrid adaptive differential evolution algorithm is designed which has the following calculation idea:

S2.1: firstly, accurately searching the solution of the engine model by the hybrid damped Newton's method based on the data of engine model design points (initial value table of the iteration variables) as the starting point of iteration; wherein the damped Newton's method is an N-R method with a damping factor, which has the basic principle that the non-linear equation F(X) is expanded according to taylor series and first-order approximation is taken to form iterative general formulas of the independent variables:

$${X}^{k + 1} = {X}^{k} - {α}_{k} Δ X \\ Δ X = {[ \frac{\partial F ( {X}^{k} )}{\partial X} ]}^{- 1} F ( {X}^{k} ) \\ {α}_{k} = min \{ c \cdot \frac{F ( {X}_{m}^{k} )}{Δ {X}_{m}^{k}} , 1 \}$$

wherein

$$\frac{\partial F ( {X}^{k} )}{\partial X}$$

partial derivative is a jacobi matrix of F(X^{k}) and the jacobi matrix is nonsingular; αₖ is the damping factor; Xₘ^{k} represents a variable that makes

$$\frac{F ( {X}_{m}^{k} )}{Δ {X}_{m}^{k}}$$

largest in the independent variables; and c is an adjustable constant term. In the calculation of the aero-engine model, F(X^{k}) is an error E^{k} determined by the common working equation, and the differential term of the jacobi matrix is replaced by forward difference, i.e.,

$$\frac{\partial {E}^{k}}{\partial X} = \frac{Δ {E}^{k}}{Δ {X}^{k}}$$

To reduce the amount of iterative calculation, the hybrid damped Newton's method means that the damped Newton's method is used as a main algorithm and the jacobi matrix is not corrected immediately after each iteration, but the Broyden quasi-Newton method is used for calculation. According to the indexes of set convergence speed and range, two iterative algorithms are alternately used to effectively reduce the number of aerothermodynamic iteration. If the iteration result of the nth damped Newton's method is X⁽ⁿ⁾, the Broyden quasi-Newton method is used in middle m steps and the damped Newton's method is used again from n+1 step, with an iteration format as follows:

$$\{ \begin{matrix}{X}^{( n , 0 )} = {X}^{( n )} \\ {X}^{( n , j )} = {X}^{( n , j - 1 )} - {α}_{j - 1} {B}_{j - 1}^{- 1} F ( {X}^{( n , j - 1 )} ) ; {B}_{j} \\ {X}^{( n + 1 )} = {X}^{( n , m )}\end{matrix} = {B}_{j - 1} + {β}_{j - 1} \frac{( {y}_{j - 1} - {B}_{j - 1} {s}_{j - 1} ) {s}_{j - 1}^{T}}{{S}_{j - 1}^{T} {s}_{j - 1}}$$

In the formula, X^{(n,j)} represents the j^{th} use of the Broyden quasi-Newton method in the n^{th} Newton iteration; yⱼ₋₁=F(X^{(n,j)})−F(X^{(n,j-1)}); sⱼ₋₁=X^{(n,j)}−X^{(n,j-1)}; βⱼ₋₁ and αⱼ₋₁ are damping factors; and B₀ takes the jacobi matrix of X^{(n,0)} point;

S2.2: setting the maximum iteration number Nₘₐₓ¹ of the damped Newton's method; stopping the calculation and jumping to an adaptive differential evolution algorithm if the hybrid damped Newton's method does not converge or diverges iteratively (Nₗₒₒₚ¹>Nₘₐₓ¹) within the maximum iteration number Nₘₐₓ¹; stopping the iteration when equilibrium equation residuals satisfy an error range within limited iteration number, and jumping to step S3;

S2.3: initializing a population; determining the value range of each iteration variable in the adaptive differential evolution algorithm based on the characteristics of the engine components and working condition limitations, as the variable value ranges x_{j,i}^{L} and x_{j,i}^{U} of an initial population of the adaptive differential evolution algorithm; setting the initial population number NP of the differential evolution algorithm, and randomly generating the initial population {xᵢ(0)|x_{j,i}^{L}≤x_{i,j}(0)≤x_{j,i}^{U}, i=1,2, . . . , NP; j=1,2, . . . , D};

x_{j,i}(0)=x_{j,i}^{L}+rand(0,1)·(x_{j,i}^{U}=x_{i,j}^{L})

wherein x_{j,i}(0) represents the j^{th} gene of the i^{th} individual in the 0 generation; NP represents the population size; and rand(0,1) represents random numbers evenly distributed in an interval of (0,1);

selecting a residual e[m] of each common working equation (the number of equations is m) of the engine model, and taking

$${O}_{f} = \frac{1}{m} {Σ}_{0}^{m - 1} e ( j )$$

as a fitness function to serve as an optimization objective function;

S2.4: adaptive mutation strategies: attempting to use two different mutation strategies in the algorithm, and introducing probability p to control the selection of the mutation strategies; conducting self-adapting by p according to the learning experience in the calculation process, and obtaining a scaling factor F based on a Gaussian distribution function; initializing p as p=0.5; after the population fully evolves in the current round, recording the number ns1 of individuals which enter the next generation and the number nf1 of individuals not entering the next generation under the condition of Uᵢ(0,1)<p from vᵢ, and the number ns2 of individuals which enter the next generation and the number nf2 of individuals not entering the next generation under the condition of Uᵢ(0,1)≥p from vᵢ, wherein x_{best} represents a current optimal individual; respectively recording the two groups of numbers for 50 generations, called as a “learning cycle”; and when the probability p is updated after the learning cycle, resetting the values of ns1, ns2, nf1 and nf2,with the formulas of the adaptive mutation strategies shown as follows:

$${v}_{i} = \{ \begin{matrix}{x}_{i 1} + F \cdot ( {x}_{i 2} - {x}_{i 3} ) , if {U}_{i} ( 0 , 1 ) < p , ( 1 ) \\ {x}_{best} + F \cdot ( {x}_{i 1} - {x}_{i 2} ) + F \cdot ( {x}_{i 1} - {x}_{i 2} ) , otherwise . ( 2 )\end{matrix} \\ {F}_{i} = {N}_{i} ( 0.5 , 0.3 ) \\ p = \frac{ns 1 \cdot ( ns 2 + nf 2 )}{ns 2 \cdot ( ns 1 + nf 1 ) + ns 1 \cdot ( ns 2 + nf 2 )}$$

S2.5: Crossover operation. The adaptive evolution crossover operation is conducted for dimensions. The new individual has the probability of CR to select the dimension in vᵢ(j), and other dimensions select xᵢ(j) wherein the adaptive crossover rate CR allocates a crossover rate CRᵢ for each individual, CRₘ is initialized as 0.5, and CRᵢ is updated every 5 generations. In each generation, the value of CRₘ and a subgeneration successfully enter the next generation; corresponding CRᵢ enters an array CR_{rec}, and is updated every 25 generations; and after the update, CR_{rec} is emptied.

$${u}_{i} ( j ) = \{ \begin{matrix}{v}_{i} ( j ) , if {U}_{i} ( 0 , 1 ) < CR or j = {j}_{rand} \\ {x}_{i} ( j ) , otherwise .\end{matrix} \\ {CR}_{i} = {N}_{i} ( CRm , 0.1 ) \\ CRm = {\sum }_{k = 1}^{\vert {CR}_{rec} \vert} {CR}_{rec} ( k )$$

S2.6: Selection operation. The selection operation is selection of a better individual from a mutated individual uᵢ and an old individual xᵢ by using a greedy algorithm to generate a new individual x′ᵢ;

$${x}_{i}^{′} = \{ \begin{matrix}{u}_{i} , if f ( {u}_{i} ) \leq f ( {x}_{i} ) \\ {x}_{i} , otherwise .\end{matrix}$$

S2.7: Determining the number tₘₐₓ of termination steps and a termination condition (Nₗₒₒₚ²>Nₘₐₓ²) of the adaptive differential evolution iteration; accurately searching the solution of the model by the damped Newton's method based on a variable parameter obtained by the differential evolution algorithm as an iteration initial value, and stopping the iteration when the equilibrium equation residuals satisfy the error range.

S3: Establishing a dynamic calculation model of the aero-engine

S3.1: after designing the component-level model of the aero-engine by C++ codes, introducing a dynamic link library to encapsulate the engine iteration model, and introducing into simulink module. An encapsulating module is shown in FIG. 4;

S3.2: determining the sampling time of a dynamic process, and determining the input conditions of the model according to the actual working conditions of the engine to realize the simulation of the dynamic process of the aero-engine.

S4: Simulation results and analysis

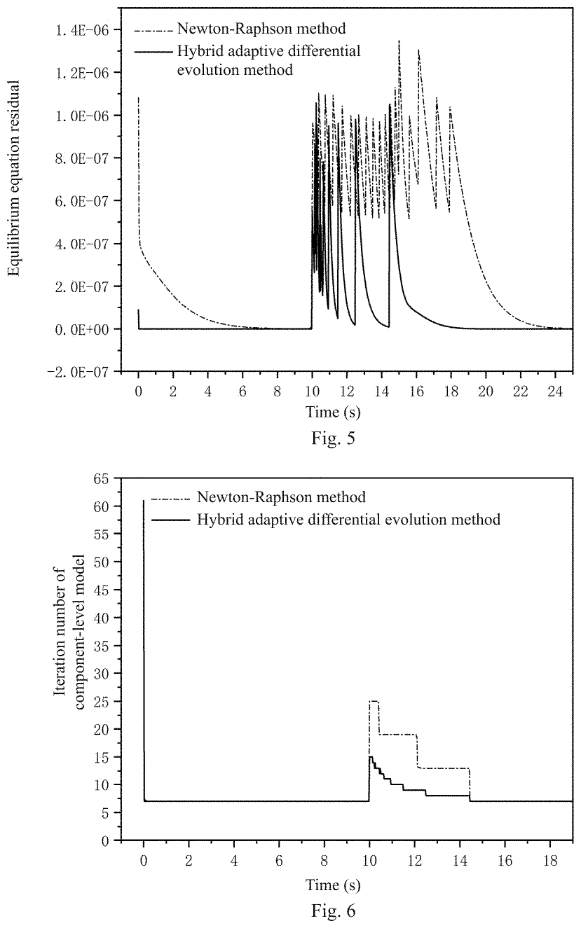

S4.1: comparing the hybrid adaptive differential evolution algorithm (Hybrid saDE) of the present invention with the traditional Newton-Raphson method. FIG. 5 shows a variation curve of dynamic errors of different iterative algorithms in a small deviation dynamic process over time. FIG. 6 shows a variation curve of the number of component calculation of different iterative algorithms over time. It can be seen that in the small deviation dynamic process, the hybrid adaptive differential evolution algorithm and the traditional Newton-Raphson method can converge in the whole process. The Newton-Raphson method has larger number of component calculation. Compared with the traditional algorithm, the hybrid adaptive differential evolution algorithm significantly improves the real-time performance of dynamic model calculation and the number of component calculation.

S4.2: Analyzing the effects of different initial values and iteration step sizes on the convergence of three iteration models (Hybrid saDE, Newton-Raphson and Broyden), and finding that the convergence of the traditional Newton-Raphson and Broyden models decreases with the increase of the initial value error norm; after the initial error is greater than 0.187, the traditional Newton-Raphson and Broyden models do not converge and the hybrid adaptive differential evolution algorithm can still ensure the convergence of the iteration even though the number of component calculation is increased in large deviation calculation.

1. An iterative algorithm for aero-engine model based on hybrid adaptive differential evolution, comprising steps of:
S1: establishing a component-level model of an aero-engine
S1.1 establishing input and output modules of a component-level inlet, fan, compressor, combustion chamber, high pressure turbine, low pressure turbine, external duct, mixing chamber, afterburner and tail nozzle based on gas flow and aerothermodynamic formulas, wherein the modeling of the fan, the compressor and the high-pressure turbine mainly adopts an interpolation method comprising characteristic lines, and different characteristic lines are used for different engine models;
S1.2: simultaneously satisfying flow, power and rotor dynamic equilibrium equation when the engine is in a steady state or dynamic working state, and representing the residual of the rotor dynamic equilibrium equation by e; based on different calculation requirements, selecting n independent variables x and conducting simultaneous solving of n common working equations:
$${f}_{1} ( {x}_{0} , {x}_{1} , {x}_{2} , … , {x}_{n} ) = {e}_{1} \\ {f}_{2} ( {x}_{0} , {x}_{1} , {x}_{2} , … , {x}_{n} ) = {e}_{2} \\ … … \\ {f}_{n} ( {x}_{0} , {x}_{1} , {x}_{2} , … , {x}_{n} ) = {e}_{n}$$
S1.3: determining environmental input parameters of the model based on the operating state of the engine model: Mach number, flight height, main fuel flow, afterburner fuel flow and tail nozzle area, wherein the problem essentially becomes non-linear implicit equations with unknown independent variables, and the engine model is considered to obtain a reliable solution when six residual values of the common working equation approach 0;
S2: solving the engine model by a hybrid adaptive differential evolution algorithm
In order to solve the non-linear implicit equations of the aero-engine model, a hybrid adaptive differential evolution algorithm is designed which has the following calculation idea:
S2.1: firstly, accurately searching the solution of the engine model by the hybrid damped Newton's method based on the data of engine model design points as the starting point of iteration; wherein the damped Newton's method is an N-R method with a damping factor, which has the basic principle that the non-linear equation F(X) is expanded according to taylor series and first-order approximation is taken to form iterative general formulas of the independent variables:
$${X}^{k + 1} = {X}^{k} - {α}_{k} Δ X \\ Δ X = {[ \frac{\partial F ( {X}^{k} )}{\partial X} ]}^{- 1} F ( {X}^{k} ) \\ {α}_{k} = min \{ c \cdot \frac{F ( {X}_{m}^{k} )}{Δ {X}_{m}^{k}} , 1 \}$$
wherein
$$\frac{\partial F ( {X}^{k} )}{\partial X}$$
partial derivative is a jacobi matrix of F(X^{k}) and the jacobi matrix is nonsingular; αₖ is the damping factor; Xₘ^{k} represents a variable that makes
$$\frac{F ( {X}_{m}^{k} )}{Δ {X}_{m}^{k}}$$
largest in the independent variables; and c is an adjustable constant term; in the calculation of the aero-engine model, F(X^{k}) is an error E^{k} determined by the common working equation, and the differential term of the jacobi matrix is replaced by forward difference, i.e.,
$$\frac{\partial {E}^{k}}{\partial X} = \frac{Δ {E}^{k}}{Δ {X}^{k}}$$
to reduce the amount of iterative calculation, the hybrid damped Newton's method means that the damped Newton's method is used as a main algorithm and the jacobi matrix is not corrected immediately after each iteration, but the Broyden quasi-Newton method is used for calculation; according to the indexes of set convergence speed and range, two iterative algorithms are alternately used to effectively reduce the number of aerothermodynamic iteration; if the iteration result of the n^{th} damped Newton's method is X⁽ⁿ⁾, the Broyden quasi-Newton method is used in middle m steps and the damped Newton's method is used again from n+1 step, with an iteration format as follows:
$$\{ \begin{matrix}{X}^{( n , 0 )} = {X}^{( n )} \\ {X}^{( n , j )} = {X}^{( n , j - 1 )} - {α}_{j - 1} {B}_{j - 1}^{- 1} F ( {X}^{( n , j - 1 )} ) ; {B}_{j} \\ {X}^{( n + 1 )} = {X}^{( n , m )}\end{matrix} = {B}_{j - 1} + {β}_{j - 1} \frac{( {y}_{j - 1} - {B}_{j - 1} {s}_{j - 1} ) {s}_{j - 1}^{T}}{{S}_{j - 1}^{T} {s}_{j - 1}}$$
in the formula, X^{(n,j)} represents the j^{th} use of the Broyden quasi-Newton method in the n^{th} Newton iteration; yⱼ₋₁=F(X^{(n,j)})−F(X^{(n,j-1)}); sⱼ₋₁=X^{(n,j)}−X^{(n,j-1)}; βⱼ₋₁ and αⱼ₋₁ are damping factors; and B₀ takes the jacobi matrix of X^{(n,0)} point;
S2.2: setting the maximum iteration number Nₘₐₓ¹ of the damped Newton's method; stopping the calculation and jumping to an adaptive differential evolution algorithm if the hybrid damped Newton's method does not converge or diverges iteratively (Nₗₒₒₚ¹>Nₘₐₓ¹) within the maximum iteration number Nₘₐₓ¹; stopping the iteration when equilibrium equation residuals satisfy an error range within limited iteration number, and jumping to step S3;
S2.3: initializing the population; determining the value range of each iteration variable in the adaptive differential evolution algorithm based on the characteristics of the engine components and working condition limitations, as the variable value ranges x_{j,i}^{L} and x_{j,i}^{U} of an initial population of the adaptive differential evolution algorithm; setting the initial population number NP of the differential evolution algorithm, and randomly generating the initial population {xᵢ(0)|x_{j,i}^{L}≤x_{i,j}(0)≤x_{j,i}^{U}, i=1,2, . . . , NP; j=1,2, . . . , D};
x_{j,i}(0)=x_{j,i}^{L}+rand(0,1)·(x_{j,i}^{U}=x_{i,j}^{L})
wherein x_{j,i} (0) represents the j^{th} gene of the i^{th} individual in the 0 generation; NP represents the population size; and rand(0,1) represents random numbers evenly distributed in an interval of (0,1);
selecting a residual e[m] of each common working equation of the engine model, with m as the number of equations, and taking
$${O}_{f} = \frac{1}{m} {Σ}_{0}^{m - 1} e ( j )$$
as a fitness function to serve as an optimization objective function;
S2.4: adaptive mutation strategies: attempting to use two different mutation strategies in the algorithm, and introducing probability p to control the selection of the mutation strategies; conducting self-adapting by p according to the learning experience in the calculation process, and obtaining a scaling factor F based on a Gaussian distribution function; initializing p as p=0.5; after the population fully evolves in the current round, recording the number ns1 of individuals which enter the next generation and the number nf1 of individuals not entering the next generation under the condition of Uᵢ(0,1)<p from vᵢ, and the number ns2 of individuals which enter the next generation and the number nf2 of individuals not entering the next generation under the condition of Uᵢ(0,1)≥p from vᵢ, wherein x_{best} represents a current optimal individual; respectively recording the two groups of numbers for 50 generations, called as a “learning cycle”; and when the probability p is updated after the learning cycle, resetting the values of ns1, ns2, nf1 and nf2, with the formulas of the adaptive mutation strategies shown as follows:
$${v}_{i} = \{ \begin{matrix}{x}_{i 1} + F \cdot ( {x}_{i 2} - {x}_{i 3} ) , if {U}_{i} ( 0 , 1 ) < p \\ {x}_{best} + F \cdot ( {x}_{i 1} - {x}_{i 2} ) + F \cdot ( {x}_{i 1} - {x}_{i 2} ) , otherwise\end{matrix} \\ {F}_{i} = {N}_{i} ( 0.5 , 0.3 ) \\ p = \frac{ns 1 \cdot ( ns 2 + nf 2 )}{ns 2 \cdot ( ns 1 + nf 1 ) + ns 1 \cdot ( ns 2 + nf 2 )}$$
S2.5: crossover operation: conducting the adaptive evolution crossover operation for dimensions, wherein a new individual has the probability of CR to select the dimension in vᵢ(j), and other dimensions select xᵢ(j) wherein the adaptive crossover rate CR allocates a crossover rate CRᵢ for each individual, CRₘ is initialized as 0.5, and CRᵢ is updated every 5 generations; in each generation, the value of CRₘ and a subgeneration successfully enter the next generation; corresponding CRᵢ enters an array CR_{rec}, and is updated every 25 generations; and after the update, CR_{rec} is emptied;
$${u}_{i} ( j ) = \{ \begin{matrix}{v}_{i} ( j ) , if {U}_{i} ( 0 , 1 ) < CR or j = {j}_{rand} \\ {x}_{i} ( j ) , otherwise .\end{matrix} \\ {CR}_{i} = {N}_{i} ( CRm , 0.1 ) \\ CRm = {\sum }_{k = 1}^{\vert {CR}_{rec} \vert} {CR}_{rec} ( k )$$
S2.6: selection operation: the selection operation is selection of a better individual from a mutated individual uᵢ and an old individual xᵢ by using a greedy algorithm to generate a new individual x′ᵢ;
$${x}_{i}^{′} = \{ \begin{matrix}{u}_{i} , if f ( {u}_{i} ) \leq f ( {x}_{i} ) \\ {x}_{i} , otherwise .\end{matrix}$$
S2.7: determining the number tₘₐₓ of termination steps and a termination condition (Nₗₒₒₚ²>Nₘₐₓ²) of the adaptive differential evolution iteration; accurately searching the solution of the model by the damped Newton's method based on a variable parameter obtained by the differential evolution algorithm as an iteration initial value, and stopping the iteration when the equilibrium equation residuals satisfy the error range;
S3: establishing the dynamic calculation model of the aero-engine
S3.1: after designing the component-level model and the iterative algorithm of the aero-engine, introducing a dynamic link library to encapsulate the engine iteration model;
S3.2: determining the sampling time of a dynamic process, and determining the input conditions of the model according to the actual working conditions of the engine to realize the simulation of the dynamic process of the aero-engine.
